(19) United States
(12) Patent Application Publication
(10) Pub. No.: US 2007/0195766 A1
(43) Pub. Date: Aug. 23, 2007

(54) VIRTUALIZED SERVICES SYSTEM AND METHOD

(75) Inventors: Goutham Sukumar, Sammamish, WA (US); Mrinal Bhasker, Bothell, WA (US); Prem Urali, Redmond, WA (US)

Correspondence Address: AXIOS LAW GROUP, 1725 WESTLAKE AVENUE NORTH, SUITE 150, SEATTLE, WA, 98109, US

(73) Assignee: HEALTHUNITY CORPORATION, Bellevue, WA (US)

(21) Appl. No.: 11/681,736

(22) Filed: Mar. 2, 2007

Related U.S. Application Data
(63) Continuation-in-part of application No. 11/611,124, filed on Dec. 14, 2006.
(60) Provisional application No. 60/767,087, filed on Mar. 2, 2006.
(60) Provisional application No. 60/597,637, filed on Dec. 14, 2005.
(60) Provisional application No. 60/743,752, filed on Mar. 24, 2006.

(51) Int. Cl. H04L 12/56

(52) U.S. Cl. 370/389

(57) ABSTRACT

A virtualized service system and method are provided herein.

### RELATED APPLICATIONS

This application is a non-provisional claiming the benefit of U.S. Provisional Patent Application No. 60/767,087, entitled VIRTUALIZING SERVICES SYSTEM AND METHOD, with the named inventors Goutham Sukumar, Mrinal Bhasker and Prem S. Urali, filed on Mar. 2, 2006; and a continuation-in-part of U.S. patent application Ser. No. 11/611,124 entitled SECURE COMMUNICATION SYSTEM AND METHOD, with the named inventors Prem S. Urali, John Azariah, Kumar Ranvijay, and Mrinal Bhasker, filed on Dec. 14, 2006, which is a non-provisional claiming the benefit of U.S. Provisional Patent Application No. 60/597,637, entitled SECURE COMMUNICATION SYSTEM AND METHOD, with the named inventors Prem S. Urali, John Azariah, Kumar Ranvijay, and Mrinal Bhasker, filed on Dec. 14, 2005; the entireties of which are hereby incorporated by reference.

### FIELD

The present invention generally relates to digital communications, and more specifically to digital communications for performing data services.

### BACKGROUND

In a communication and collaboration computer network, there may be several entities that provide a certain set of computing related resource and services, and several entities that utilize or consume such resources or services. In such a network, it may be beneficial to enable various service consumers to utilize services available in the network regardless of the location where each of these services are installed or deployed.

Communications between electronic devices have also improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term Internetwork is “internet.” As currently understood, the capitalized term “Internet” 200 refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Networked appliances are generally a combination of hardware and software components that provide, among other functionality, communications between different organizations.

There are a number of existing technologies that can enable utilization of computing components across any type of computer network.

One such technology is a client server model, where client components consume services that are provided by one or more server components. Under this mechanism, client components, typically, but not restricted to. Software applications present one or more requests using a communication mechanism to a server component, which interprets the requests and performs the requested computation, and then returns the results of the computation to the client component that requested it. However, in the contexts of highly distributed, hybrid peer to peer systems, it is hard to provide a client-server model of processing request due to the following reasons.

Cost of providing services including the hardware, software and maintenance may be high, making it hard to put server components at each peer in the network. Deploying these services centrally may also be inappropriate due to the high volume of requests that will have to be processed from the high number of peers that exist in the system. In addition, some services may require a high volume of data to be fed in for computation and some may return a high volume of data as the result of computations. Different sets of peers in a hybrid network may also require different configurations of services, making it difficult of expensive to deploy the services centrally. Finally, different organizations which collaborate in a peer to peer network may have differing policies around how data from the organization may be transmitted externally. Some may prohibit such data exchange for any purpose.

Another alternative mechanism for processing request in a distributed system may be a completely independent peer to peer system where each peer has the necessary infrastructure to process the requests originating at their own nodes. Such a configuration will ensure that each peer is self sufficient and insulated from the others. In such a system, if the server components required to process the requests are expensive, the expense may have to be applied many fold in the overall system regardless of the extent to which each peer utilizes its own server infrastructure. This may lead to wastage of computational resources as well as incurring of high software and hardware costs at each of the peer locations.

### BRIEF DESCRIPTION OF THE DRAWINGS

FIG. 1 is a system diagram of a number of devices in a peer-to-peer network in accordance with one embodiment.

FIG. 2 is a block diagram of a network services interface device that provides an exemplary operating environment for one embodiment.

FIG. 3 is a block diagram of an appliance that provides an exemplary operating environment for one embodiment.

FIG. 4 is a diagram illustrating the actions taken by devices in a secure communications system to register an appliance in accordance with one embodiment.

FIG. 5 is a flow diagram illustrating a registration routine in accordance with one embodiment.

FIG. 6 is a diagram illustrating the actions taken by devices in a secure communications system for sending a secure message in accordance with one embodiment.

FIG. 7 is a flow diagram illustrating an introduced secure message routine in a sending appliance in accordance with one embodiment.

FIG. 8 is a flow diagram illustrating an introduced secure message routine on the network services interface in accordance with one embodiment.

FIG. 9 is a flow diagram illustrating an introduced secure message routine on a receiving appliance in accordance with one embodiment.

FIG. 10 is a diagram of the actions by devices in a secure communications system for sending a secure message between persons in accordance with one embodiment.

FIG. 11 is a flow diagram illustrating the person-to-person secure message processing on a receiving appliance in accordance with one embodiment.

FIG. 12 is a flow diagram illustrating service registration between network devices in accordance with one embodiment.

FIG. 13 is a diagram of the actions by devices in a virtual services system for performing a local service in accordance with one embodiment.

FIG. 14 is a diagram of the actions by devices in a virtual services system for performing a remote service in accordance with one embodiment.

FIG. 15 is a flow diagram illustrating a processing a service request in accordance with one embodiment.

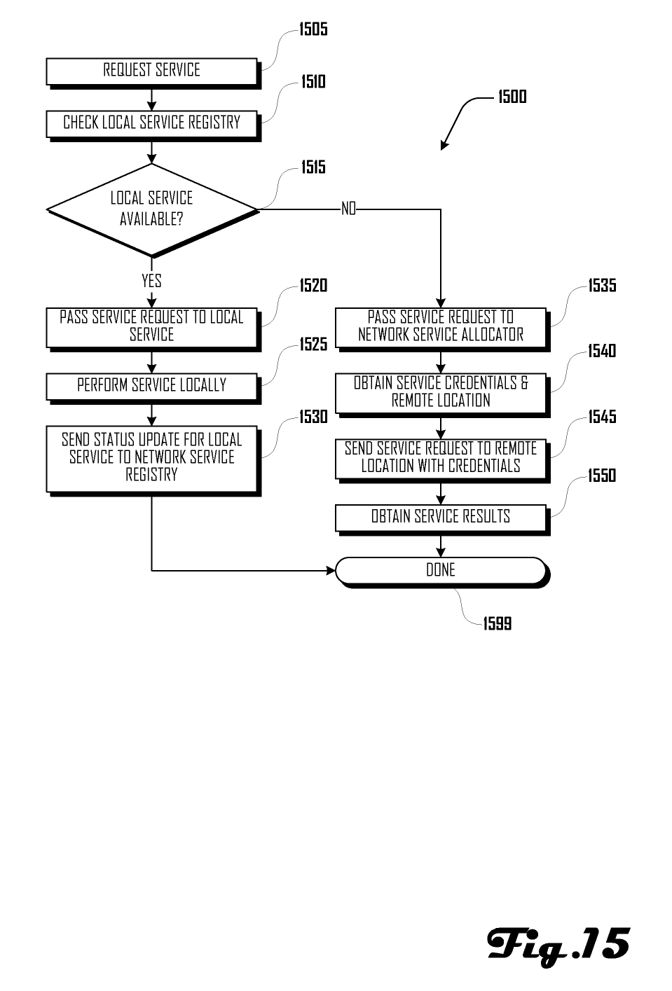

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Organizations would like to leverage the ubiquitous and inexpensive Internet for communication even for sensitive and private scenarios. For example two organizations in the financial services industry may want to communicate the data about a customer with each other; a primary care physician may want to communicate her patient's data to a specialist who is also going to treat the given patient; or two intelligence agencies may want to communicate a classified report with each other.

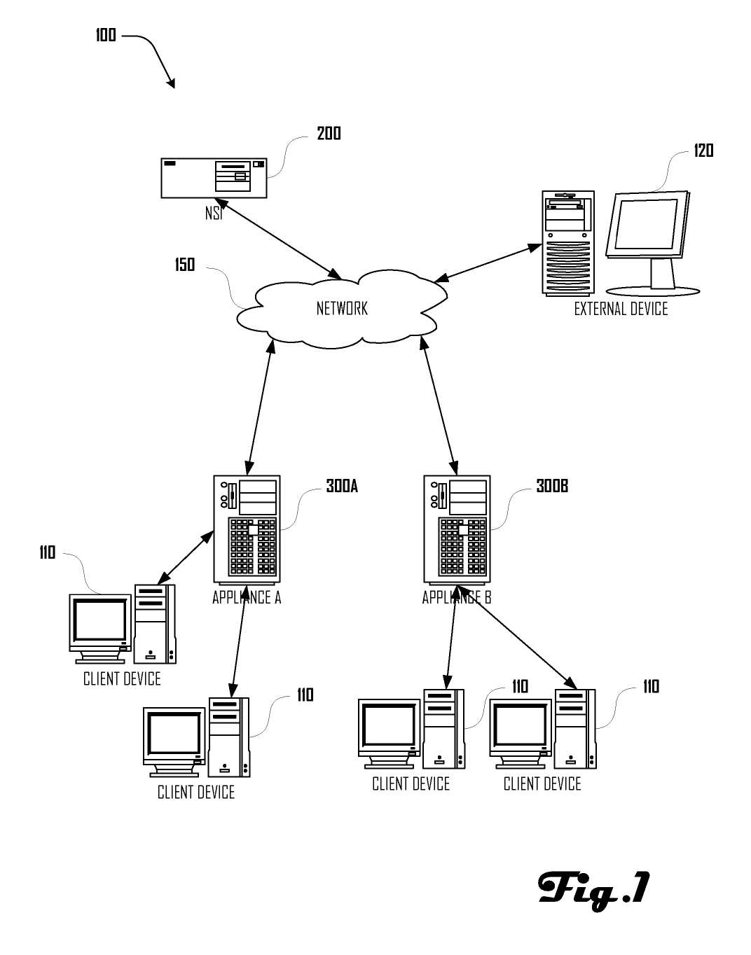

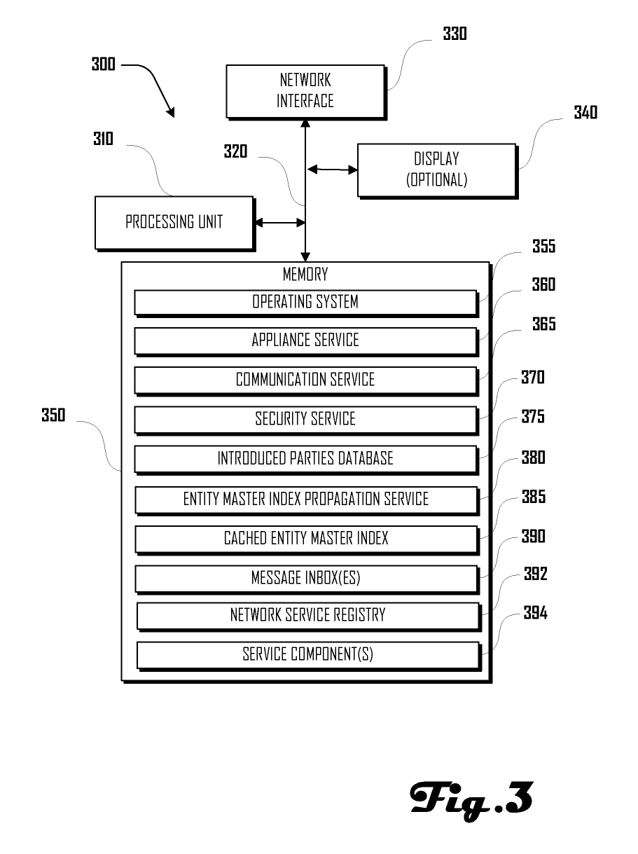

FIG. 1 illustrates a network where appliances 300 belonging to different organizations participate in communications with one another using peer-to-peer communications (or other forms of electronic communications). In FIG. 1, Organizations exchange information between one another. Each organization may have a corresponding Appliance 300A-B, or alternatively may be associated with an appliance that is shared between different organizations (not shown). An Appliance 300 (illustrated in FIG. 3 and described below) is a computer or device that contains the software services used by an organization to communicate with another organization. The client devices 110 may comprise computers and/or programs/applications which expose the services provided by the system 100 to the human users, or may also include programs that integrate data from other applications that reside within the organizations or outside them.

The secure communications system 100 (“system”) represents a set of technologies which enable each of the Appliances 300A-B to exchange messages with one another securely and privately on behalf of the organization that is represented by the appliance. The Network Services Infrastructure 200 (“NSI”) may include software services as well as hardware that enable the coordination of the communications between the different appliances 300AB.

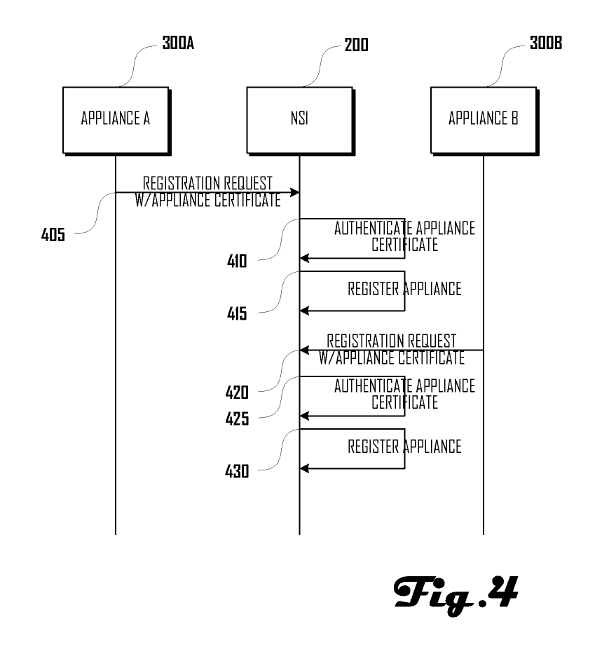

In one exemplary embodiment, any given pair of appliances 300A-B communicating with each other in a peer-to-peer fashion can mutually authenticate each other initially with the help of NSI 200 that introduces the appliances to each other. Once the mutual introduction is performed, the appliances can communicate with each other securely independent of the NSI 200 (see FIG. 4 and below).

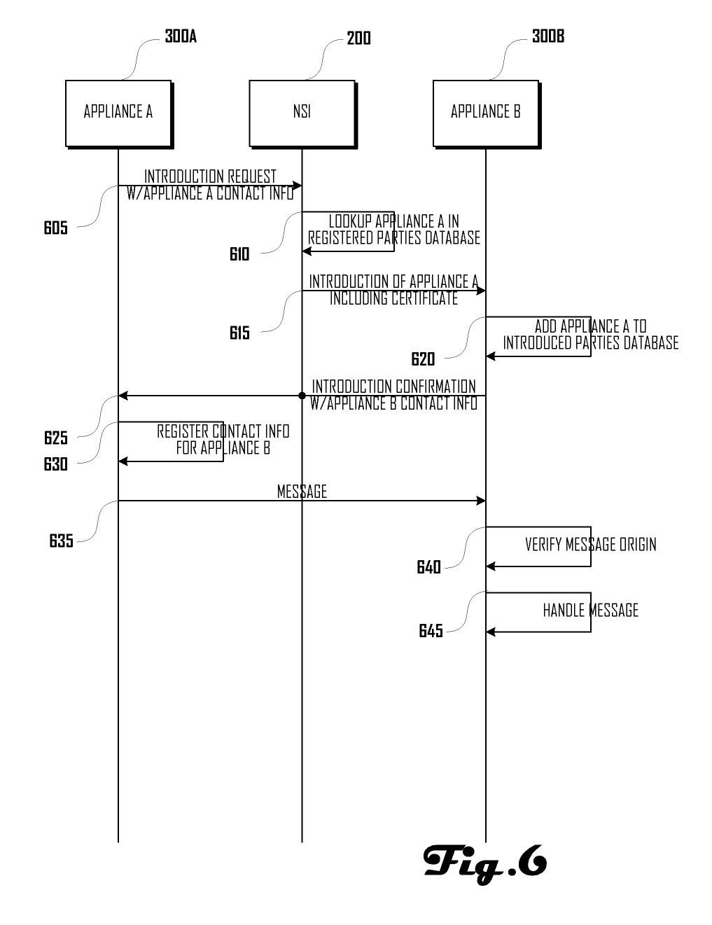

Once the introduction is performed, the communication can be two-way, with no restriction on which appliance has to initiate it (see FIG. 6 and below). The only times when the NSI 200 may be involved is when one of the appliances fails to establish communication with the other. For example, when one appliance fails/ceases to respond and the other appliance becomes unable to send a request to the failed appliance. Alternately, if the dynamically assigned Internet address of one Appliance 300A-B changes and this prevents the other appliance from reaching the changed Appliance 300A-B using the earlier Internet address.

When an Appliance 300A-B fails to connect to another already introduced Appliance 300A-B at the known Internet address, it contacts the NSI 200 to find the new location of the target Appliance 300A-B. The Appliance 300A-B will continue to periodically check with the NSI 200 until the Internet address provided by the NSI 200 proves to be useful in contacting the target Appliance 300A-B.

When any Appliance 300A-B detects a failure or a “resetting” event for itself, such as being restarted, having the Internet address changed, or the like, it performs a registration with the NSI 200. This updates the NSI 200 with the information needed by other appliances to reach the registered appliance.

If an Appliance 300A-B is known to be compromised (theft or other malicious event), the NSI 200 can immediately remove the compromised appliance from the list of known appliances, thus preventing other appliances from interacting with the compromised appliance or vice-a-versa. Such prohibition of communications for any source other than one in the list of known appliances may be implemented at any level, including, but not limited to the application's refusal to process any such communication or dynamically configuring software or hardware firewall mechanisms to ignore communications from unknown appliances and sources.

The NSI 200 can also send a message to all the other appliances (since it knows the location of each of the appliances) notifying them of the compromise, thus causing them to clear their respective available appliance lists.

In one embodiment, end users may perform trusted communications with each other as follows. A central repository, called the Entity Master Index 275 is maintained in the NSI 200 which contains the list of all the trusted end-users in the network. This list of trusted end-users may be referred to as the “Global Address Book” of the system.

In addition to the address book, a “Location Map” list is also maintained as part of the Entity Master Index 275 at the NSI 200 which associates each end user with the different appliances where the respective end user is located. For example, Dr. John Smith is a physician with details present in the Global Address Book. However, Dr. Smith may practice at two separate locations, Clinic A and Clinic B. In this case, besides having his name and address shown in the Global Address Book, Dr. John smith may also have two records in the “Location Map”, one associating him with Clinic A and the other associating him with Clinic B.

The Global Address Book as well as the Location Map may be optionally propagated to the individual appliances 300A-B periodically by the NSI 200.

At each Appliance 300A-B, an administrator may map the local appliance users to one or more entities in the Global Address book. This is the Local Identity Map (not shown).

When a user requires sending a secure message to another user in the network, he/she performs a lookup in the Global Address Book to select the recipient(s) of the message. When the message is sent, the underlying secure communications subsystem uses the Location Map to determine the Appliance 300A-B to which the message needs to be routed, and sends the message optionally in an encrypted form.

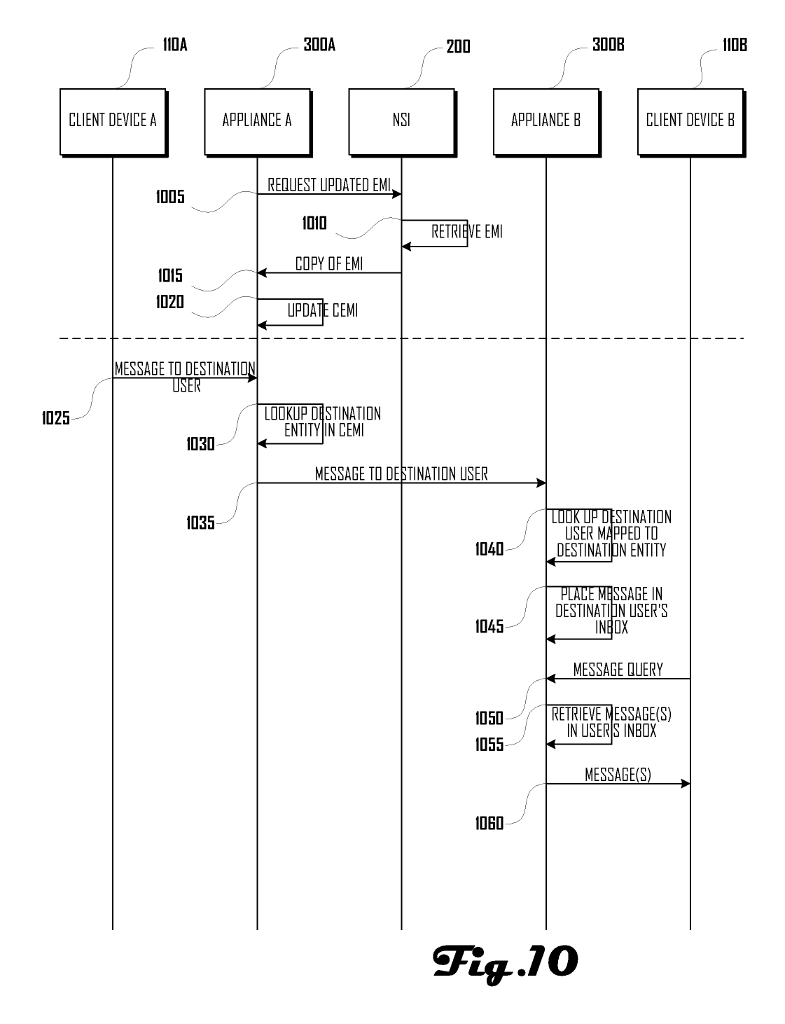

At the receiving end, the receiving Appliance 300A-B looks up the Local Identity Map to determine which end user(s) of the appliance are mapped to the Global Address Book entry to which the message is addressed. Once it finds the appliance user(s) mapped to the recipient(s), it copies the message to the inbox of the recipient user(s), who then has access to the secure communication (see FIG. 10, and description below).

In the context of a healthcare scenario, the components in FIG. 1 may correspond to the following specific instances. Each organization may correspond to healthcare providers, health-related services or other entities that deal with and needs to exchange healthcare related information. Each Appliance 300A-B may correspond to the hardware on which the software services that, in addition to other functions enable communication between the corresponding organization and other organizations in the network.

Client devices 110 may correspond to computing device, programs or web portals that expose the information and functionality of the system 100 to end users or those programs or software systems that exchange data between the system and other internal information systems at an organization.

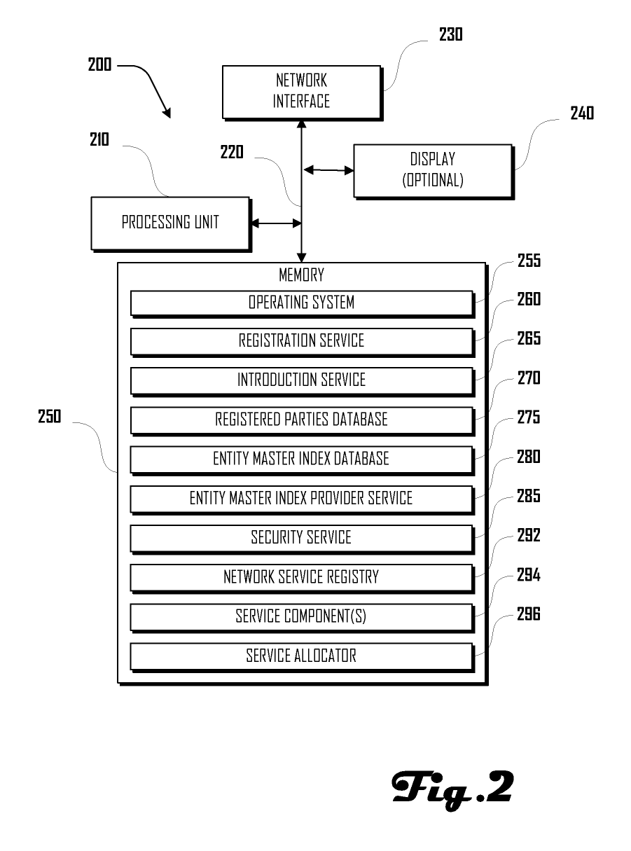

To show the operations of such communication networks, FIG. 1 illustrates an exemplary integrated secure communication system 100 having a number of devices used in exemplary embodiments. FIG. 1 illustrates a Network Service Infrastructure Device (“NSI”) 200 (illustrated in FIG. 2 and described below), a first and second appliance 300A,300B (illustrated in FIG. 3 and described below), a network 150, such as a wired or wireless communications network, and an external device 120. Also in communication with the appliances 300A-B are a number of client devices 110.

In alternate embodiments, there may be more appliances 300, NSI 200 or client devices 110. In further embodiments, the roles of one or more of an appliance 300, client device 110, NSI and/or an external device 120 may be performed by an integrated device (not show) or may be distributed across multiple other devices (not shown). In still further embodiments, still additional devices (not shown) may be utilized in the communication system 100.

In one example embodiment, different components of the system 100 may be used in a healthcare scenario, enabling interaction between different organizations using the Internet in a secure and trusted fashion. For example a hospital could use Appliance A 300A, and a physician could use Appliance B 300B (other practice, and labs may be included in more complicated scenarios) to collaborate securely with one another over the Internet 200. All of the above Appliances 300A-B may use the NSI 200 for coordinating the communication between them.

FIG. 2 illustrates several components of an exemplary NSI 200. In some embodiments, the NSI 200 may include many more components than those shown in FIG. 2. However, it is not necessary that all of these generally conventional components be shown in order to disclose an illustrative embodiment. As shown in FIG. 2, the NSI 200 includes a network interface 230 for connecting to the network 150. Those of ordinary skill in the art will appreciate that the network interface 230 includes the necessary circuitry for such a connection and is constructed for use with the appropriate protocol.

The NSI 200 also includes a processing unit 210, a memory 250 and may include an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for registration service 260, introduction service 270, registered parties database 270, entity master index database 275, entity master index provider service 280, and security service 285. In addition, the memory 250 also stores an operating system 255. It will be appreciated that these software components may be loaded from a computer readable medium into memory 250 of the NSI 200 using a drive mechanism (not shown) associated with a computer readable medium, such as a floppy disc, tape, DVD/CD-ROM drive, memory card, via the network interface 230 or the like.

Although an exemplary NSI 200 has been described that generally conforms to conventional general purpose computing devices, those of ordinary skill in the art will appreciate that a NSI 200 may be any of a great number of devices capable of communicating with the network 150 or with the appliances 300.

FIG. 3 illustrates several components of an exemplary appliance 300. In some embodiments, the appliance 300 may include many more components than those shown in FIG. 3. However, it is not necessary that all of these generally conventional components be shown in order to disclose an illustrative embodiment. As shown in FIG. 3, the appliance 300 includes a network interface 330 for connecting to the network 150. Those of ordinary skill in the art will appreciate that the network interface 330 includes the necessary circuitry for such a connection and is constructed for use with the appropriate protocol.

The appliance 300 also includes a processing unit 310, a memory 350 and may include an optional display 340, all interconnected along with the network interface 330 via a bus 320. The memory 350 generally comprises a RAM, a ROM, and a permanent mass storage device, such as a disk drive. The memory 350 stores program code for appliance service 360, communication service 365, security service 370, introduced parties database 375, entity master index propagation service 380, cached entity master index 385, and message inbox(es) 390. It will be appreciated that these software components may be loaded from a computer readable medium into memory 350 of the appliance 300 using a drive mechanism (not shown) associated with a computer readable medium, such as a floppy disc, tape, DVD/CD-ROM drive, memory card, via the network interface 330 or the like.

Although an exemplary appliance 300 has been described that generally conforms to conventional general purpose computing devices, those of ordinary skill in the art will appreciate that an appliance 300 may be any of a great number of devices capable of communicating with the network 150 or with NSI 200.

FIGS. 4-11 illustrate exemplary steps to process secure communications in an exemplary secure communication system 100. Some transactions in the secure communication system 100 may be more or differently networked than others. Accordingly, in some embodiments, the number and types of devices may vary.

Appliance Registration:

When two appliances 300A-B from different organizations desire to communicate between themselves, they use the authenticated and introduced model of communication to accomplish it. Before such communication can work, the system needs to ensure that each appliance is registered with the NSI 200. This is achieved by the process of appliance registration.

FIG. 4 depicts an exemplary registration process for Appliance A 300A and Appliance B 300B. On startup, the Appliance Service application 360 on Appliance A 300A sends 405 a request to the Registration Service 260 on the Network Service Infrastructure 200 to register itself. When the Registration Service 260 receives a request, it authenticates 410 the certificate associated with the appliance and if found to be authentic, updates 415 the Registered Parties Database 270.

A similar series of steps are performed for other appliances such as Appliance B 300B. Appliance B 300B sends 420 a request to the Registration Service 260 on the Network Service Infrastructure 200 to register itself. When the Registration Service 260 receives a request, it authenticates 425 the certificate associated with the appliance and if found to be authentic, updates 430 the Registered Parties Database 270.

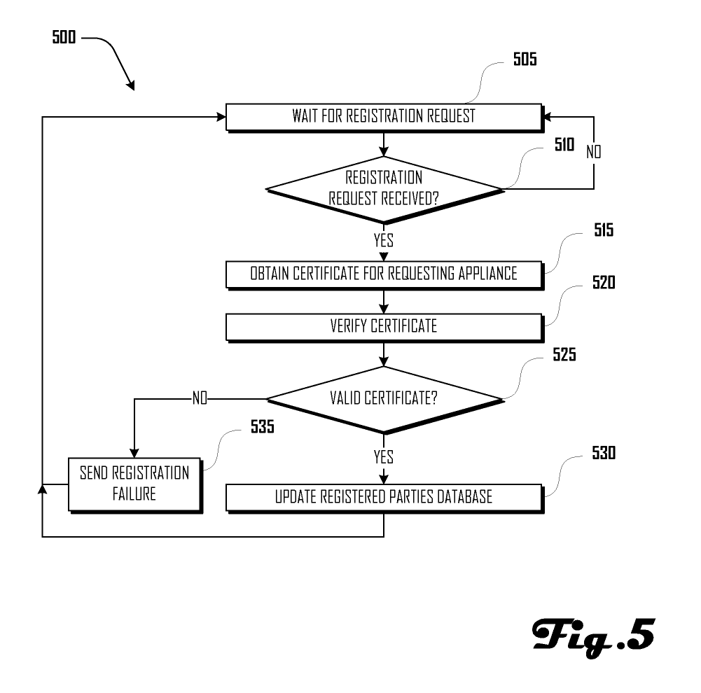

FIG. 5 illustrating an exemplary registration routine 500 on the NSI 200. Registration routine 500 begins at block 505 where the routine 500 waits for a registration request (e.g., from an Appliance 300). Next, in decision block 510 a determination is made where a registration request was received, if so, processing proceeds to block 515. Otherwise processing cycles back to block 505.

In block 515 a digital certificate of the requesting appliance 300 is obtained. In block 520, the certificate is verified. Next, in decision block 525 a determination is made whether the certificate is valid (e.g., corresponds to the requester, has not been revoked, has not expired and the like). If the certificate is valid, process continues to block 530, where the registered parties database 270 is updated with the appliance's certificate. If the certificate was not valid, a registration failure is sent to the requester in block 535. Routine 500, in any case, cycles back to block 505 where it waits for a new request.

Introduction and Communication:

Once two appliances have been introduced, they may communicate with each other. The origin appliance can begin to communicate with the destination appliance as long as both of them continue to use the same Internet address. A reintroduction is initiated if any of the appliances experiences a change in the Internet address, or any other failure during the course of communications. This mode of introduced communications is depicted by FIG. 6.

In FIG. 6, when appliance A 300A desires to communicate with Appliance B 300B, the address of which is not known, the following are the sequence of events that take place. Appliance A 300A requests 605 of the Introduction service 265 in the NSI 200 to be introduced to appliance B 300B. Introduction service 265 looks up 610 the Registered Parties Database 270 to find the address of appliance B 300B.

Introduction service 265 then contacts 615 Appliance B 300B with information about Appliance A 300A. Appliance Service 360 on Appliance B 300B enters 620 the address of Appliance A 300A into its own Introduced Parties Database 375.

Application Service 360 might also perform additional activities such as configuring other mechanisms (such as a configurable software or hardware firewall) that aid in filtering out communications from unknown sources.

Introduction service 265 obtains an introduction confirmation and forwards 625 the result of the introduction process to Appliance A 300A, also including the current contact address of Appliance B 300B. Appliance A 300A registers 630 the address of Appliance B 300B in its Introduced Parties Database 375. Communication service 365 at Appliance A 300A sends 635 the communication/message to the Communication service 365 at Appliance B 300B. Communication service 365 at Appliance B 300B looks up and validates 640 the address of Appliance A 300A in its local Introduced Parties Database 375, finds the source of the communication to be valid and handles 645 the message.

This introduced mode of communication serves a number of purposes. It ensures that any change in the address of a node does not cause inter-node communications to fail. It also ensures that in case of a node being compromised, it can be isolated from the rest of the network. Additionally, it also ensures that the identity of each node is authenticated before any other nodes are allowed to communicate with it, as well as before it is allowed to communicate with any other node.

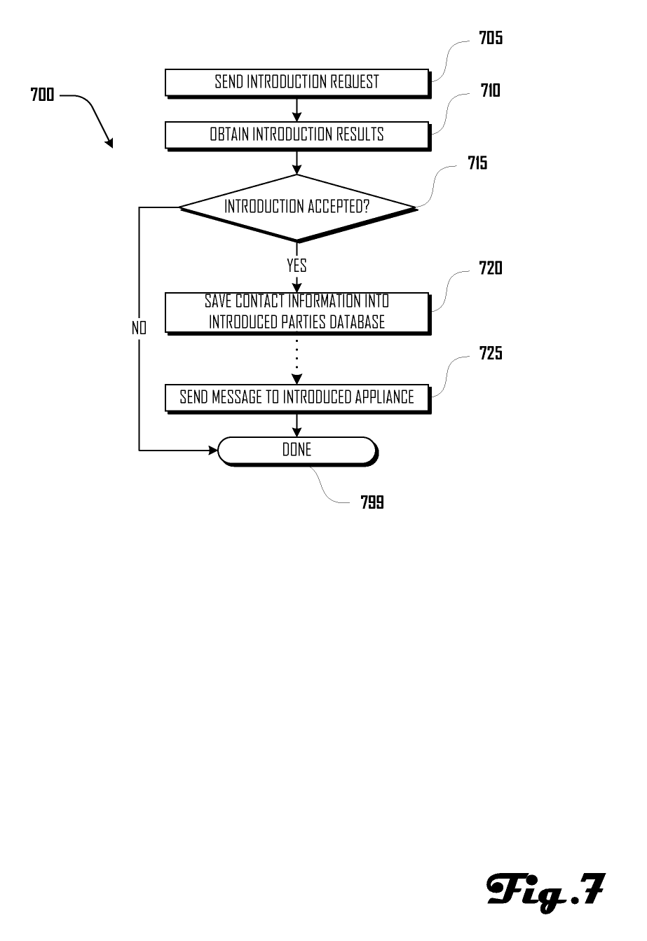

FIGS. 7-9 illustrate exemplary flow diagrams of the processes performed at devices within the system 100 to communicate a secure message.

FIG. 7 illustrates an exemplary flow diagram of an introduced communication routine 700 performed at a requesting appliance to initiate a secure communication with a destination appliance. Introduced communication routine 700 begins at block 705, where an introduction request is sent to a trusted introduction device (e.g., the NSI 200 or the like). The results of the introduction request are obtained in block 710. Next, in decision block 715, a determination is made whether the introduction was accepted. If so, in block 720 the contact information for the destination appliance is saved into the introduced parties database 375. If not, processing would proceed to block 799.

Once the contact information of the destination appliance has been saved, at some future point, as shown in block 725, a message may be sent to the introduced appliance. Routine 700 ends at block 799.

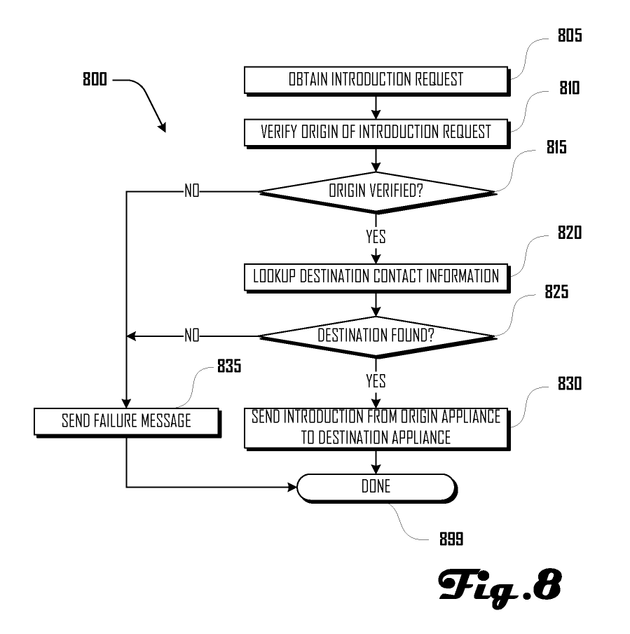

FIG. 8 illustrates an exemplary flow diagram of an introduced communication routine 800 performed at the NSI 200 to facilitate a secure communication with a destination appliance. Introduced communication routine 800 begins at block 805 where an introduction request is obtained. In block 810, the origin of the introduction request is verified (e.g., by checking the registered parties database 270). If the origin is verified, as determined in decision block 815, processing proceeds to block 820, where the destination appliance's contact information is looked up. If the origin was not verified, processing would proceed to block 835, where a failure message would be sent to the requester and routine 800 would end at block 899.

If a destination's contact information was looked up successfully, as determined in decision block 825, processing proceeds to block 830, where an introduction of the requester appliance is sent to the destination appliance and processing proceeds to block 899. If a destination's contact information was not found, as determined in decision block 825, processing would proceed to block 835 as noted above.

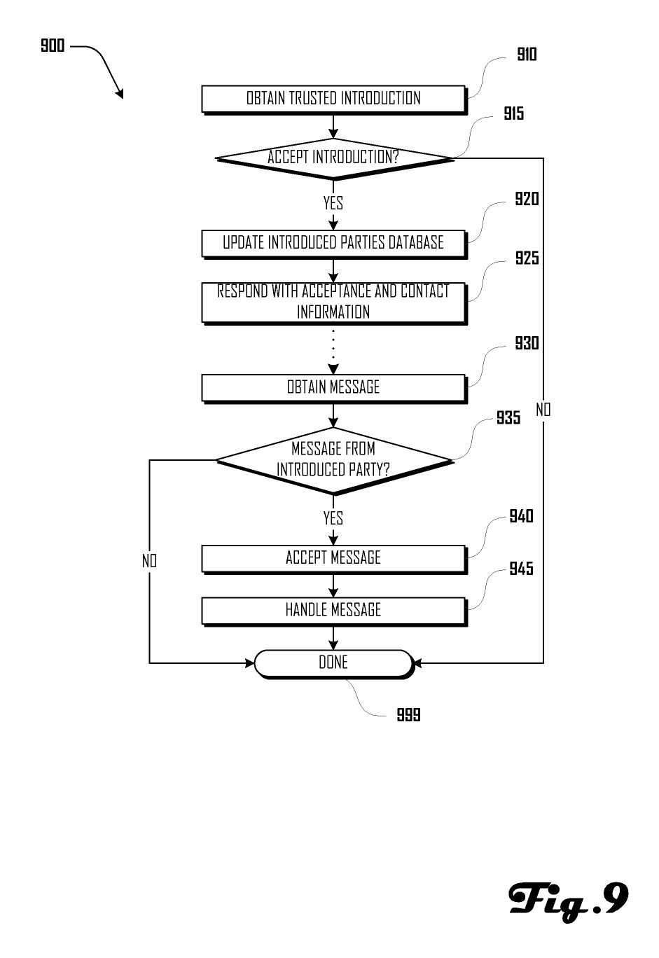

FIG. 9 illustrates an exemplary flow diagram of an introduced communication routine 900 performed at a destination appliance. Routine 900 begins at block 910 where a trusted introduction is obtained (e.g., from NSI 200, or the like). If, as determined in decision block 915, the introduction is accepted, processing proceeds to block 920. Otherwise, processing proceeds to block 999, where routine 900 ends.

In block 920, the introduced parties database 375 is updated with the contact information of the origin appliance requesting the introduction. In block 925, an introduction acceptance is sent to the origin appliance.

At some point, a message may be obtained (e.g., from the introduced origin appliance), as show in block 930. In decision block 935 a determination is made whether the message came from an introduced party (e.g., do they exist in the introduced parties database 375). If the message came from an unknown party, processing would simply proceed to block 999. Otherwise, if the appliance sending the message had been introduced, processing would proceed to block 940, where the message would be accepted. In block 945 the destination appliance would handle the message and processing would end at block 999.

Person to Person Communications:

The inter-appliance communications described above may be leveraged by a secure person-to-person communication infrastructure described below. This exemplary embodiment of person-to-person communications supplements the introduced communications mechanism explained above.

This person-to-person communications may use the Entity Master Index 275 (“EMI”). The EMI 275 enables each Appliance 300A-B to expose to its client devices 110 the list of bona fide providers in the secure communications system 100, in order to enable a client 110 to address a secure message to any client 110 in the secure communications system 100. This enables any authorized user in the system to send a message to any other trusted and advertised provider. Before any entity can receive a secure message from another, information about the identity and location of that entity should be entered in the EMI 275.

The EMI 275, in some embodiments, has two parts: a Global Entity List (“GEL”) and the Location Map (not shown). The GEL (not shown) is a list of all users in the system 100. These correspond to the different trusted persons and other human-addressable entities in the system 100. In some embodiments, entries in the GEL list are created only after extensive verification of the identity and credentials of the person or entity, including reference checks where applicable. This ensures the trustworthiness of the entries in the GEL.

The Location Map contains a mapping of each provider to one or more appliances 300A-B in the secure communications system 100. Given the identity of any entity in the network, this enables any Appliance 300A-B to determine the peer appliance to which secure messages addressed to that entity should be directed.

The Security and Role Repository (not shown) contains the identities of all the end users of the Appliance 300A-B and the roles assigned to them. Additionally, for each end user, it also enables the administrator to assign one or more user identities from the GEL, thus declaring that global entity to be assigned to the local end user.

In order to identify and correlate entity information between different internal systems at the practice, a Cached Entity Master Index (“CEMI”) 385 may be maintained at the appliance 300. The CEMI 385 is a replica of the EMI 275 contents, including the GEL and the Location Map. This is copied periodically to each Appliance 300A-B in order to enable users using the client application to locate and select recipients for the secure messages.

Secure Person-to-Person Messaging:

FIG. 10 depicts how person-to-person secure messaging is performed with a combination of the EMI 275 and secure trusted appliance communications described above.

Replication of the Entity Master Index:

At regular intervals, the Entity master index Propagation service 380 on Appliance A 300A requests 1005 updates to the EMI 275 information. The EMI Provider Service 280 on NSI 200 retrieves 1010 the latest information from the Entity Master Index database 275. The updated EMI information is returned 1015 to Appliance A 300A. The updates to the EMI are saved 1020 in the CEMI 385 by the EMI Propagation Service 380. Such replication of the EMI is optional and may be useful if the client devices 110 need access to the information without having to make a round trip to the original source of information at the NSI 200.

Person/Machine to Person Communication:

The following are exemplary steps that may take place when a client device A 110A connected to appliance A 300A requests to send a secure message to a person registered at a different appliance. A user using Client Device A 110A, requests 1025 a secure message to be sent to another person. Such a request to send a message to another person may not only be performed by a person, but also performed by a program using an application programming interface. The information about the appliance where the recipient entity is present is retrieved 1030 by the Secure Messaging Service 370 from the CEMI 385. Assume the destination user/recipient is registered at appliance B 300B. The secure Messaging Service 370 calls the Communication service 365 to send a secure message to Appliance B 300B. Using the secure introduced communication mechanism, the Communication service 365 on appliance A sends 1035 the message to the Communication service 365 on appliance B 300B. The Communication service 365 on Appliance B 300B passes the message to the secure messaging service 370 on the same appliance. The secure messaging service 370 consults 1040 the CEMI 385 to retrieve the entity at Appliance B 300B who is associated with the person to whom the message is addressed. The secure messaging service 370 places 1045 the secure message in the Message Inbox 390 with the recipient user ID set to the local user to whom the person is mapped. The recipient user, using the client device B 110B, associated with Appliance B 300B, requests 1050 to view the incoming secure messages. The request is sent to the Secure messaging Service 370. Secure messaging service 370 retrieves 1055 the incoming messages from the Message Inbox 390, which includes the new message that has arrived for that user. Secure messaging service 370 returns 1060 the incoming message(s) to client B 110B, where the recipient user receives and views the secure message.

As an alternative, the person sending or receiving a secure message may be replaced by a software program or other device that is designed to do so, on a person's/entity's behalf.

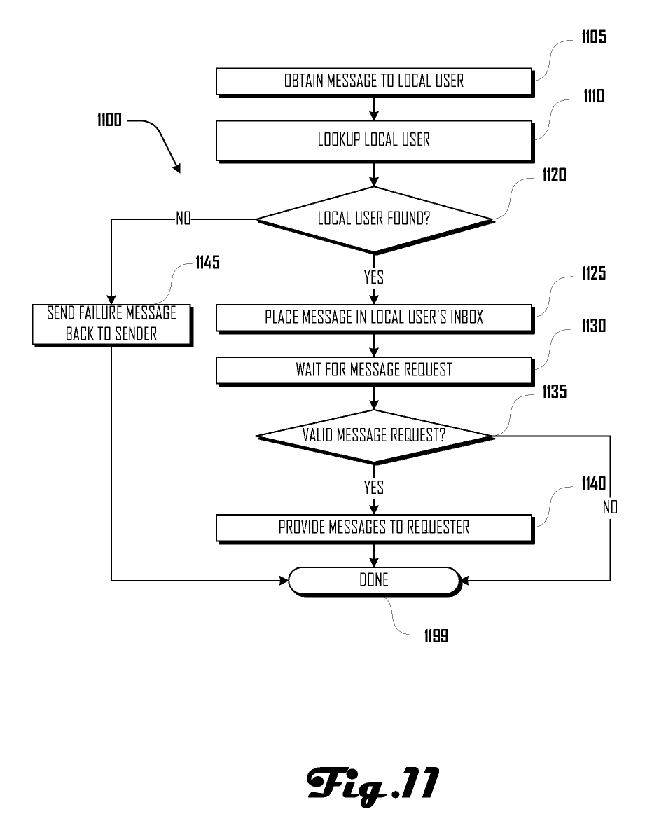

FIG. 11 illustrates an exemplary flow diagram of a person-to-person introduced communication routine 1100 performed at the receiving appliance to facilitate a secure communication to a destination user. Routine 1100 begins at block 1105, where a message to a local user is obtained. In block 1110 the local user is looked up. If, as determined in decision block 1120, the local user is found, processing proceeds to block 1125. Otherwise, a failure message is sent back to the message sender in block 1145 and routine 1100 ends at block 1199.

In block 1120 the message is placed in the user's inbox 390 on the receiving appliance. Routine 1100 waits in block 1130 until a message request is received. Once a valid message request is received, as determined in decision block 1135, the message(s) in the user's inbox 390 are provided to the requester in block 1140. After the messages have been received, or if the message request was invalid, routine 1100 ends at block 1199.

In addition to messages, organizations would like to leverage the ubiquitous and inexpensive Internet for providing services that are commonly used by multiple entities. For example different branches of an organization in the financial services industry may want to use a common set of services for performing financial modeling for customer accounts. In the healthcare industry, two physicians may want to share the same common Data services to convert healthcare information to a common format. Multiple intelligence agencies may want to use a set of shared services to analyze fingerprints to identify matching individuals.

In addition to coordinating the communications between different nodes, the NSI 200 may also include a list of registered service providers, such as within a Network Service Registry 292 along with additional information pertaining to each of the services they expose. This additional information may include, but is not limited to, the current utilization of the service, the configuration information about the service, the load being applied on the service and the availability of the service. These attributes of a service provider may be used by a prospective consumer of the service (For example, Appliance B 300B) to determine which service provider in the system 100 should be invoked to perform the specific service it requires.

In one exemplary embodiment illustrated in FIG. 1, any given set of sites/Appliances A-B 300A-B communicating and collaborating with each other in a peer-to-peer fashion can utilize one of the Service Components (294, 394) to perform transformation of data from a given set of source formats to a given set of destination formats.

Such utilization of shared resources (Data services is an example of such a resource) can be achieved by the nodes (appliances 300 or their clients 110) in the system 100 without regard to the actual location/appliance where these actual services are present and available. In addition, the lack of availability of any of the Data service instances can be accounted for by the system 100 by routing the requests for such services to the ones that are available.

Network Service Registry:

The network service registry 292 is a collection of information about the different services that exist in the entire network. This is kept up-to-date by each service component (294, 394) at regular intervals, to maintain an accurate list of services available and additional information corresponding to each service.

Local Service Registry:

The local service registries 392 are repositories of information about the different services that are available in the respective local appliance or the NSI 200. The local service registry 392 is kept up-to-date by each local service component 394 of the Appliance 300, at regular intervals, to maintain an accurate list of services available and additional information corresponding to each service.

Service Registration:

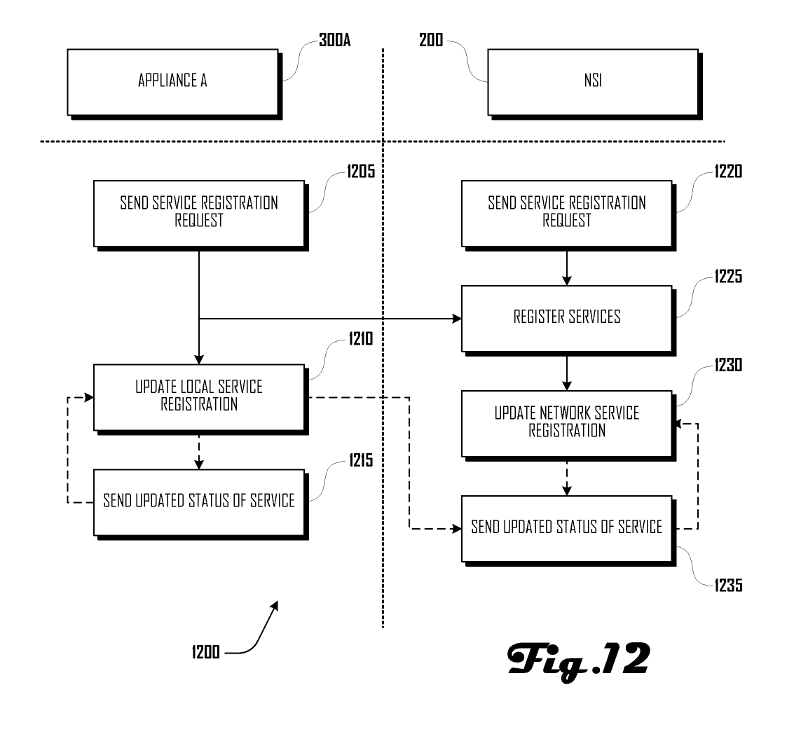

FIG. 12 illustrates an exemplary process of registering a service in the system 100. When the Service components (294, 394) start, each of them sends a request (1205, 1220) to the NSI 200, which in turn registers the services (1225) in the Network Service Registry 292. Service component 394 also updates (1210) the Local Service Registry 392 directly, updating information about itself that only prospective consumers on the local appliance 300A can access. Likewise Network Service component 294 also updates (1230) the Network Service Registry 292 directly, updating information about itself that networked prospective consumers connected to the NSI 200 can access. Once the service registration is performed, each of the service components (294, 394) may be available to accept service requests from any (or a restricted set) of prospective consumers of their services.

At regular intervals, or when specific events occur, each service component (294, 394) may send (1215, 1235) updates status information about themselves to the Local Service Registry 392 as well as the Network Service Registry 292. These specific events may include, but are not limited to, the receipt of a request for processing, the completion of a request, shutting down of the service etc. The additional information sent to the Network Service Registry 292 and the Local Service registry 392 may include but is not restricted to, the number of requests processed by the service, information about the average time the respective service takes to process a request, local resource availability, and the state of the service (Active/Inactive/Paused/Processing are some examples of service state).

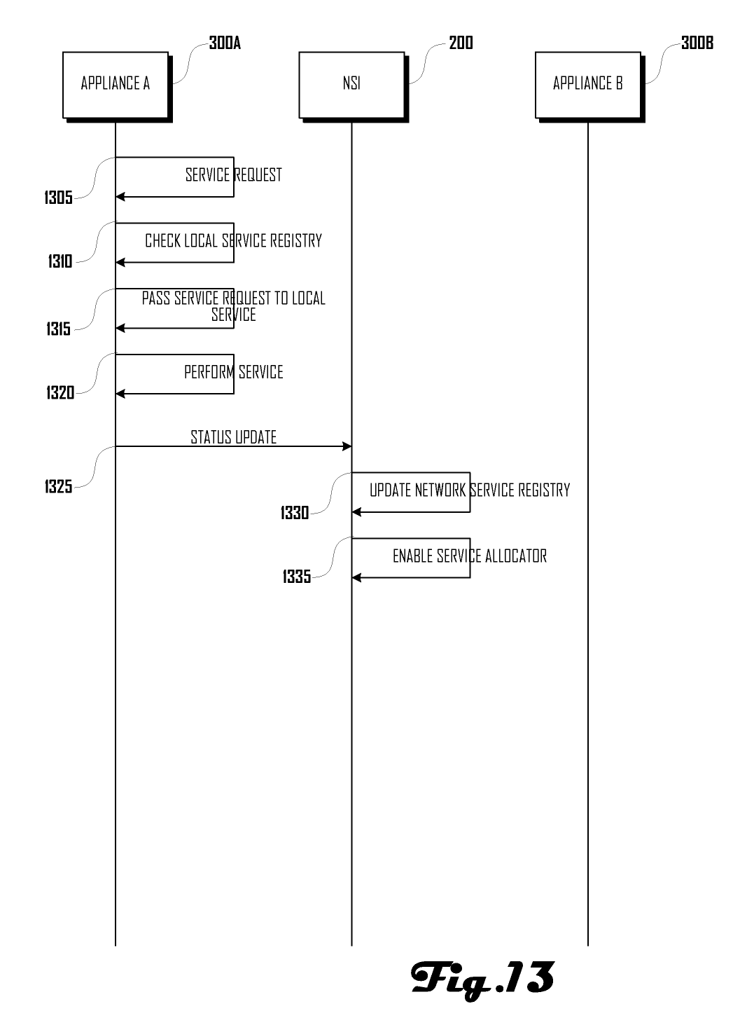

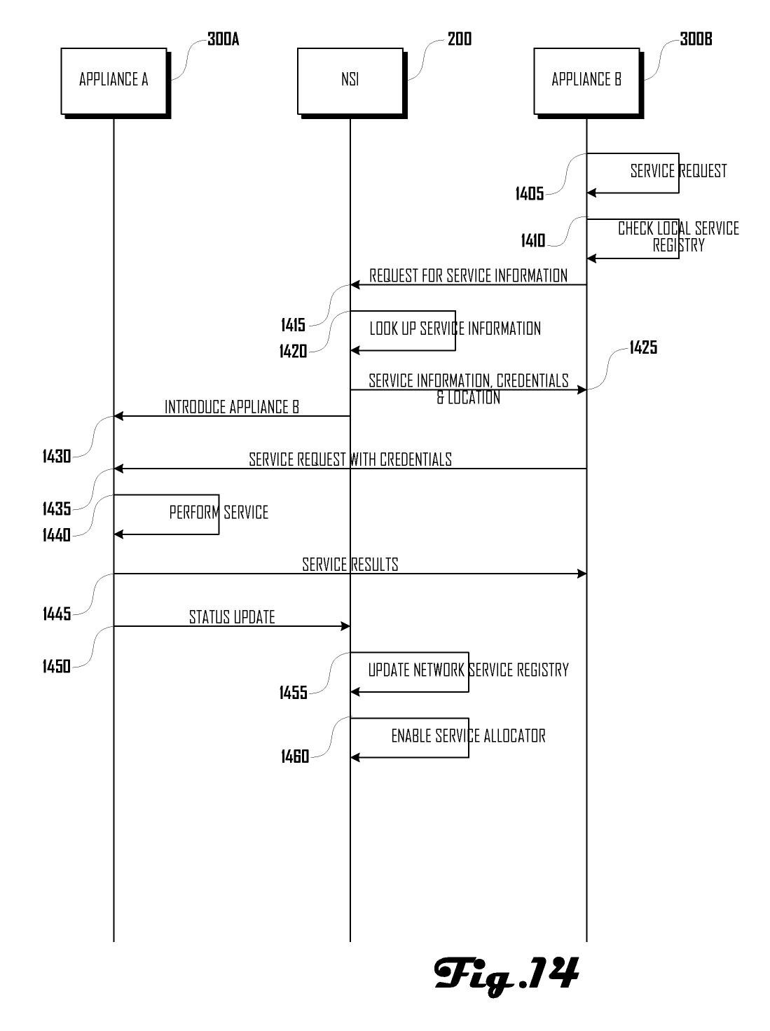

The architecture of example devices that consume Data services are shown in FIGS. 13-14

Processing Using a Local Service:

FIG. 13 illustrates processing a local service. When a Client 110 requests to perform a service, it requests 1305 the service. The Appliance A 300A checks 1310 the local service registry 392 to determine that the local system already has a running instance of the Service component 394 that matches the requested service. Next the local service component 394 is passed 1315 the inputs to perform the requested service. The Service Component 394 takes the provided inputs, performs 1320 the requested processing and if the processing is successful, returns the result to the Client 110. If the processing failed for some reason, the error information is returned to the Client 110.

Optionally, once the processing is completed by the Service Component 394, Appliance A 300A may send 1325 an update to the Network Service Registry 292 (and/or the Local service Registry 392) with information such as current load on the service component 394, the number of requests processed and the availability or status. Such updates may be optional, and the service may perform these updates at regular intervals, after processing each request, after processing a number of requests, or never at all. When such an update is received by the NSI 200, it updates 1330 the information about the service into the Network Service Registry 292, which subsequently may enable 1335 the Service Allocator 296 to make allocation decisions with the most current information.

Processing Using a Remote Service:

FIG. 14 illustrates processing a local service. When a Client 110 of Appliance B 300B which does not have a local service available requires a service, it may make a request 1405 on the local appliance, Appliance B 300B for the service. The Appliance B 300B makes a decision of which actual instance of Service in the system 100 the request will be routed to and processed by. While it does not necessarily perform the requested service, it may hold the responsibility of first determining the location of correct service to use, and forwarding the request to an appropriate service implementation at the chosen location. It may also be responsible for receiving the result of the processing and passing it back to the entity that requested the service.

The example of FIG. 14 shows the sequence of events that happen when a Client 110 requests a service and Appliance B 300B does not have the service available (e.g., there is no instance of the desired service component 394 on Appliance B 300B). Additionally, this example illustrates the case when the Service Allocator 296 determines that the Service Component 394 on Appliance A 300A is the optimal service component 394 to use. A similar sequence of events may occur if the service is performed by a Service Component 294 hosted on the NSI 200.

When a Client 110 of Appliance B 300B requests 1405 to perform a service, Appliance B 300B determines, by checking 1410 in the Local Service Registry 392) that there is no available service on Appliance B 300B. This causes Appliance B 300B to contact 1415 the Service Allocator 296 component in the NSI 200, with a request to provide information on the most appropriate service component to use. The Service Allocator 296 receives the request, the parameters of which may include, but are not limited to those that describe the type of service requested, the amount of data that needs to be passed to the service and the location from where the call originated. With these parameters, it looks up 1420 in the Network Service Registry 292 to determine the most appropriate service to use. This determination may be based on various factors including, but not limited to, the type of service requested, the desired configuration of service instance, availability of the service instance, proximity to the requesting service, number of outstanding requests to the service instance, average turn-around times for the service instance. Based on one or more of the actual factors used in the selection, the Service Allocator 296 returns 1425 to Appliance B 300B, the location and credentials of the selected service to be used, along with an optional count of the number of requests that may be forwarded to the selected Service Instance. This is to avoid Appliance B 300B from having to contact the Service Allocator 296 too frequently for each request it needs to process. The Service Allocator 296 may additionally perform an introduction 1430 of the requesting appliance (Appliance B 300B) to the appliance on which the service instance is running (Appliance A 300A).

When Appliance B 300B receives the address and credentials for the selected service (assume Service Component 394 on Appliance A 300A is selected) from the Service Allocator 296, Appliance B 300B may send 1435 the service request in a secure and trusted manner to the corresponding Service Component 394 at the destination appliance (Appliance A 300A). The Service Component 394, in turn performs the service 1440, and returns 1445 the results on successful completion or error information on a failure back to Appliance B 300B.

Optionally, once the processing is completed by the Service Component 394, Appliance A 300A may send 1450 an update to the Network Service Registry 292 (and/or the Local service Registry 392) with information such as current load on the service component 394, the number of requests processed and the availability or status. Such updates may be optional, and the service may perform these updates at regular intervals, after processing each request, after processing a number of requests, or never at all. When such an update is received by the NSI 200, it updates 1455 the information about the service into the Network Service Registry 292, which subsequently may enable 1460 the Service Allocator 296 to make allocation decisions with the most current information.

In some embodiments, when any Appliance 300A-B detects a failure or a “resetting” event for itself, such as being restarted, having the Internet address changed, or the like, it performs a registration (see FIG. 12) of all the locally available services (Example: Service Component 394) on the NSI 200. This updates the Network Service Registry 292 on the NSI 200 with the current information needed by other appliances to discover the registered service.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. For example, while only two appliances 300A-B have been describes, in further embodiments, many more appliances may be used. This application is intended to cover any adaptations or variations of the embodiments discussed herein.

1. A computer-implemented method of virtualizing data services in a networked environment, the method comprising:
obtaining a service request from a local device;
determining that a desired data service unavailable at a local device;
querying a trusted allocation device for a location and credentials of a remote device where said desired data service is available;
introducing said local device to said remote device by providing said credentials for said local device to said remote device;
securely requesting said desired data service of said remote device; and
securely obtaining the results of said data service from said remote device.

2. The method of claim 1, further comprising verifying said local device.

3. The method of claim 1, further comprising verifying said remote device.
